(19) United States
(12) Patent Application Publication
(10) Pub. No.: US 2008/0048925 A1
(43) Pub. Date: Feb. 28, 2008

(54) Sliding-Type Portable Wireless Set

(75) Inventors: Hideyuki Soutome, Tokyo (JP); Tomohiro Takahashi, Tokyo (JP); Tohru Fukasawa, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignees: Mitsubishi Electric Corporation, Chiyoda-ku, Tokyo (JP); NTT DoCoMo, Inc, Chiyoda-ku, Tokyo (JP)

(21) Appl. No.: 11/577,251

(22) PCT Filed: Oct. 21, 2004
(86) PCT No.: PCT/JP04/15626

§ 371 Date: Apr. 13, 2007

(51) Int. Cl. H01Q 1/48

(52) U.S. Cl. 343/846

(57) ABSTRACT

One ground conductor and the other ground conductor have a sliding structure, and the other ground conductor is provided with a radiating element. These one ground conductor and other ground conductor are provided with one connecting terminal and the other connecting terminal, respectively, which get into an electrically connected state each other in drawing-out. Further, it is arranged that a load be connected in series between the other connecting terminal and the other ground conductor, and one ground conductor and the other ground conductor are electrically connected to each other through the load in drawing-out.

### TECHNICAL FIELD

The present invention relates to a sliding-type portable wireless set able to be drawing out or housing it by sliding a plurality of casings.

### BACKGROUND ART

In general, a portable wireless set connects ground conductors to one another by a flexible cable, in order to exchange an electric signal between two or more ground conductors. At this time, a current induced in the ground conductors is almost determined by the size of the ground conductors, or the length, the width, and a connecting location of the flexible cable, which are mainly determined depending on what design one adopts for the portable wireless set. For this reason, even if the electrical length of a radiating element and layout of elements are changed, there is no means for greatly changing radiating patterns. This has made it difficult to materialize a high-gain antenna best suited to a plurality of frequency bands and a variety of holding states of the portable wireless set.

To solve the above-mentioned problems, there has been existent a folding-type portable wireless set, in which a radiating element is provided on any one of a plurality of ground conductors, and which includes a linear conductor connecting the ground conductors to one another, aside from a flexible cable; and a load connected in series to the linear conductor; wherein radiating patterns are altered by changing an impedance of the load (see Patent document 1).

Patent Document 1: JP-A2003-332931

However, the above-described conventional portable wireless set relates no more than to a folding-type portable wireless set. Therefore, when contemplating applying such a structure to the sliding-type portable wireless set, the wireless set entails an extremely long linear conductor, in order to protect a breakage of the linear conductor connecting the ground conductors to one another, though its length naturally varies depending on how much slide the casings for drawing out or housing thereof.

The present invention has been made to solve the above-mentioned problems, and an object of the present invention is to provide a sliding-type portable wireless set able to materialize a high-gain antenna, best suited to a plurality of frequency bands and a variety of holding states of the portable wireless set.

### DISCLOSURE OF THE INVENTION

The sliding-type portable wireless set according to the present invention is provided with a radiating element on any one of a plurality of ground conductors, and with one and the other ground connecting terminals on one and the other ground conductors, respectively, having a sliding structure, which gets into an electrically connected state in drawing-out of these ground conductors. Further, a load is connected in series between one connecting terminal and one ground conductor, or between the other connecting terminal and the other ground conductor.

This offers a sliding-type portable wireless set, having a high-gain antenna, best suited to a plurality of frequency bands and a variety of holding states of the portable wireless set.

### BRIEF DESCRIPTION OF THE DRAWINGS

FIG. 1 is a structural diagram showing a drawn-out state of the sliding-type portable wireless set according to the first embodiment of the present invention.

FIG. 2 is a structural diagram showing a housed state of the sliding-type portable wireless set according to the first embodiment of the present invention.

FIG. 3 is a structural diagram showing each of ground conductors of the sliding-type portable wireless set according to the first embodiment of the present invention.

FIG. 4 is a table explaining a relationship between control signals and frequencies of the sliding-type portable wireless set according to the first embodiment of the present invention.

FIG. 5 is a diagram explaining an slanted state of the sliding-type portable wireless set according to the first embodiment of the present invention.

FIG. 6 is a chart explaining space radiating patterns, in an slanted state, of the sliding-type portable wireless set according to the first embodiment of the present invention.

FIG. 7 is a structural diagram showing a housed state of the sliding-type portable wireless set according to the second embodiment of the present invention.

FIG. 8 is a structural diagram showing each of ground conductors of the sliding-type portable wireless set according to the second embodiment of the present invention.

FIG. 9 is a structural diagram showing each of ground conductors of the sliding-type portable wireless set according to the third embodiment of the present invention.

FIG. 10 is a table explaining a relationship between control signals and frequencies of the sliding-type portable wireless set according to the third embodiment of the present invention.

FIG. 11 is a structural diagram showing each of ground conductors of the sliding-type portable wireless set according to the fourth embodiment of the present invention.

FIG. 12 is a structural diagram showing a drawn-out state of the sliding-type portable wireless set according to the fifth embodiment of the present invention.

FIG. 13 is a structural diagram showing a housed state of the sliding-type portable wireless set according to the fifth embodiment of the present invention.

FIG. 14 is a diagram explaining linear conductors of the sliding-type portable wireless set according to the fifth embodiment of the present invention.

### BEST MODE FOR CARRYING OUT THE INVENTION

Embodiments of the present invention will now be described with reference to the accompanying drawings for describing the present invention in more detail.

### First Embodiment

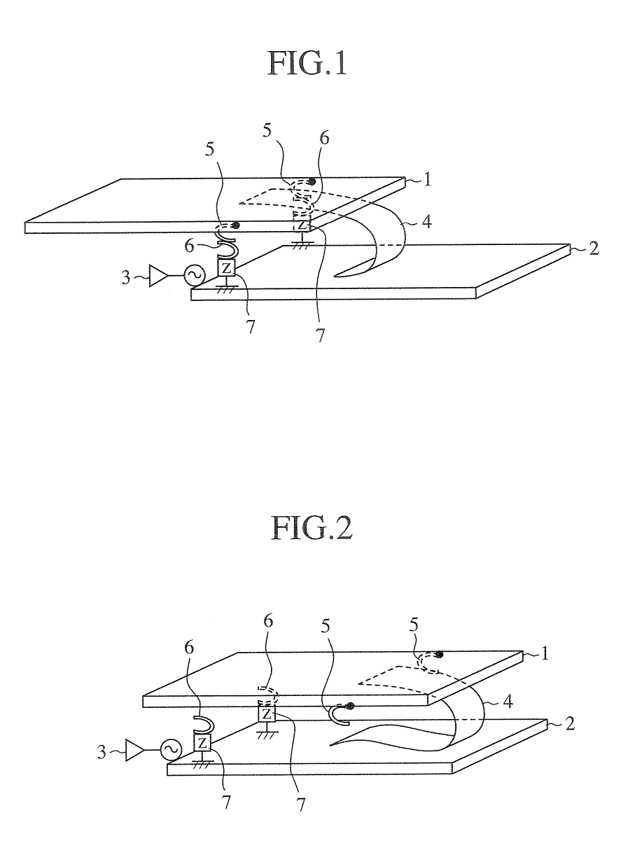

FIG. 1 and FIG. 2 are structural diagrams showing the portable wireless set according to the first embodiment of the present invention, FIG. 1 shows a drawn-out state of the casings, and FIG. 2 shows a housed state thereof.

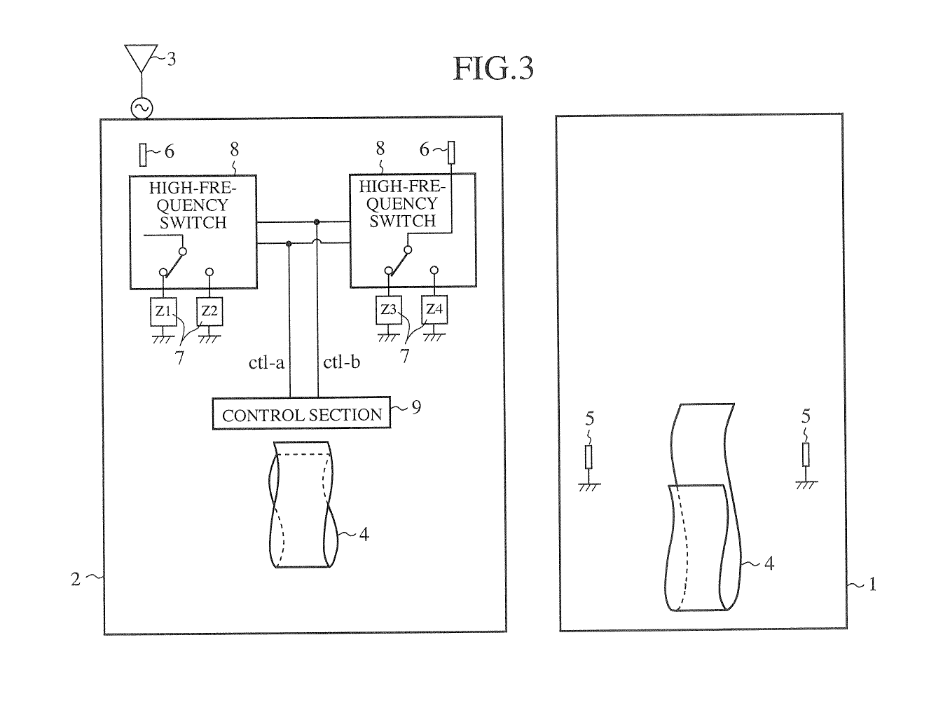

Further, FIG. 3 is a structural diagram showing each of ground conductors of the sliding-type portable wireless set according to the first embodiment of the present invention.

The sliding-type portable wireless set of the first embodiment includes one ground conductor 1; the other ground conductor 2; a radiating element 3; a linear conductor 4; one connecting terminal 5; the other connecting terminal 6; a load 7; a high-frequency switch 8; and a control section 9. On one ground conductor 1 (casing) is disposed, e.g., a speaker, display, camera, and the like. On the other ground conductor 2 (casing) is disposed, e.g., an RF circuit, battery, microphone, dial keys, camera, and the like. These one ground conductor 1 and other ground conductor 2 are arranged to have a sliding structure, including a mechanism to draw out or house the portable wireless set by sliding the ground conductors, and to get into a housed state when the portable wireless set is not in use.

The radiating element 3 is an antenna, to which electricity is supplied from an RF circuit provided on the other ground conductor 2 through a feeder line (illustration of the RF circuit and feeder line is omitted.). The linear conductor 4 mutually carries electric signals of one ground conductor 1 and those of the other ground conductor 2, using which a speaker, display, and camera are actuated. In the linear conductor 4, approximately 40 to 90 linear conductors are usually wired, and these linear conductors are bundled up to serve as the linear conductor 4 (flexible cable).

One connecting terminal 5 and the other connecting terminal 6 are connectors for connection provided to electrically connect one ground conductor 1 and the other ground conductor 2. One connecting terminal 5 is connected to one ground conductor 1 and the other connecting terminal 6 is connected to the other ground conductor 2, respectively. Further, these one connecting terminal 5 and other connecting terminal 6 are provided on both sides (two places) of the respective ground conductors with respect to a sliding direction thereof. Moreover, these one connecting terminal 5 and other connecting terminal 6 are disposed at positions, as shown in FIG. 1 and FIG. 2, at which these connecting terminals are electrically connected each other in drawing-out of the casings, and are electrically disconnected each other in housing thereof.

The load 7 is connected in series to the other connecting terminal 6, of which impedance is changeable. That is, the load 7 is composed, e.g., of a plurality of inductors and capacitors, and as shown in FIG. 3, it is arranged to be able to select an inductor or a capacitor to be actually used by the high-frequency switch 8, selectively operating in response to control signals from the control section 9. The high-frequency switch 8 is, e.g., a SPDT switch for switching between the two other connecting terminals 6 and the load 7 (Z1, Z2) or a load 7 (Z3, Z4) based on control signals (ctl-a, ctl-b) from the control section 9. Instead, the high-frequency switch 8 may be such a mechanical switch as a MEMS switch, a PIN diode, a variable-capacitance diode, or their equivalent.

The control section 9 is so to speak a functional section for performing a switching control of the load 7 (Z1, Z2, Z3, and Z4), and is arranged to output control signals ctl-a, ctl-b for switching the load depending on a frequency band to be used and a holding state.

The operation of the first embodiment will now be described below.

Assume that the sliding-type portable wireless set of the first embodiment is used in two frequencies f1 and f2 by way of example, and the frequency f1 is set to 2.0 GHz and the frequency f2 is set to 800 MHz. Further, suppose that control signals employing the frequency f1 are in course of being exchanged by control of the control section 9.

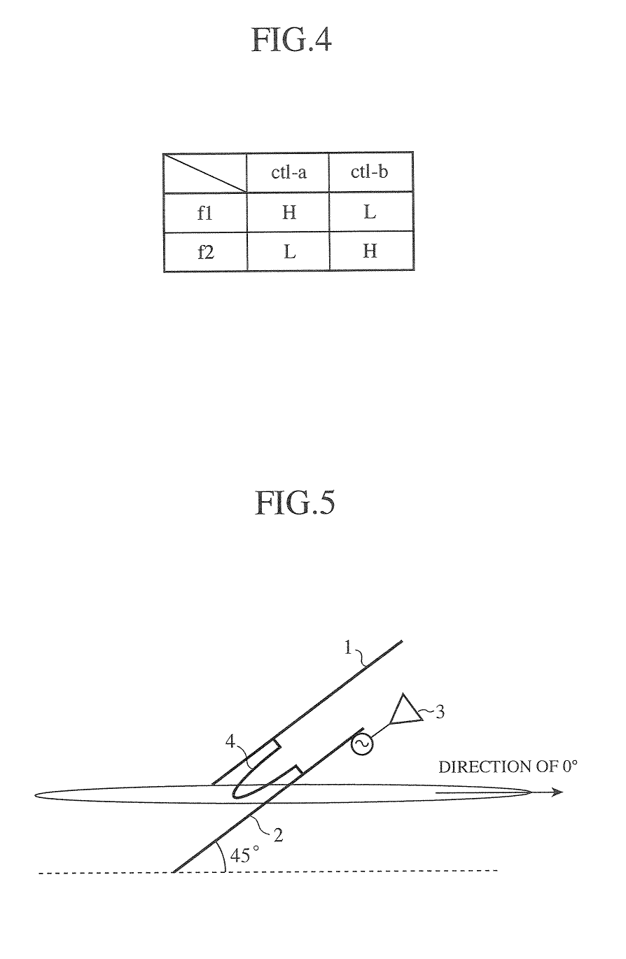

FIG. 4 is a table explaining a relationship between the control signals ctl-a, ctl-b and the frequencies f1, f2.

In case of using the wireless set at the frequency f1, the control signal ctl-a is “H” and the control signal ctl-b is “L”, and at this time, the respective high-frequency switches 8 select the load 7 (Z1) and the load 7 (Z3).

Moreover, in the sliding-type portable wireless set of the first embodiment, a currently used frequency band, a holding state of the portable wireless set, and information on a voice and data are read into the control section 9. At this moment, in the absence of a sensor capable of sensing the holding state, presume that only the information on a frequency band is read thereinto.

The control section 9 sends a signal to the high-frequency switch 8 based on such information, and the signal is detected thereby to select a proper impedance of the load 7 connected respectively to the mating high-frequency switch 8. This changes current distributions induced in one ground conductor 1 and the other ground conductor 2 to enable selection of a radiation pattern best suited to service conditions.

In order to obtain at this time the optimum radiation pattern, it is necessary to determine the load 7 with which a radiation pattern becomes optimum for each service condition (frequency bands used and holding states of the wireless set) by the help of experiments and simulations, in consideration of the service condition previously.

Here, a further explanation will be given about what effect can be obtained by changing radiation patterns.

Current portable wireless sets are furnished with a variety of capabilities such as browsing and mailing in addition to telephone calls. During mailing or browsing, the portable wireless set is held in an slanted state. Such a state lowers an antenna gain caused by a polarization loss and a human body loss due to an influence of the human body.

FIG. 5 is a diagram explaining the sliding-type portable wireless set held in such an slanted state.

According to the first embodiment, when the portable wireless set is slanted in free space, enhancing the directivity of the main polarization of the antenna attains an alleviated degradation of an antenna performance caused by the human body and a high-gain antenna performance. Remark parenthetically, in FIG. 5, the direction of 0° shows the opposite direction of the human body.

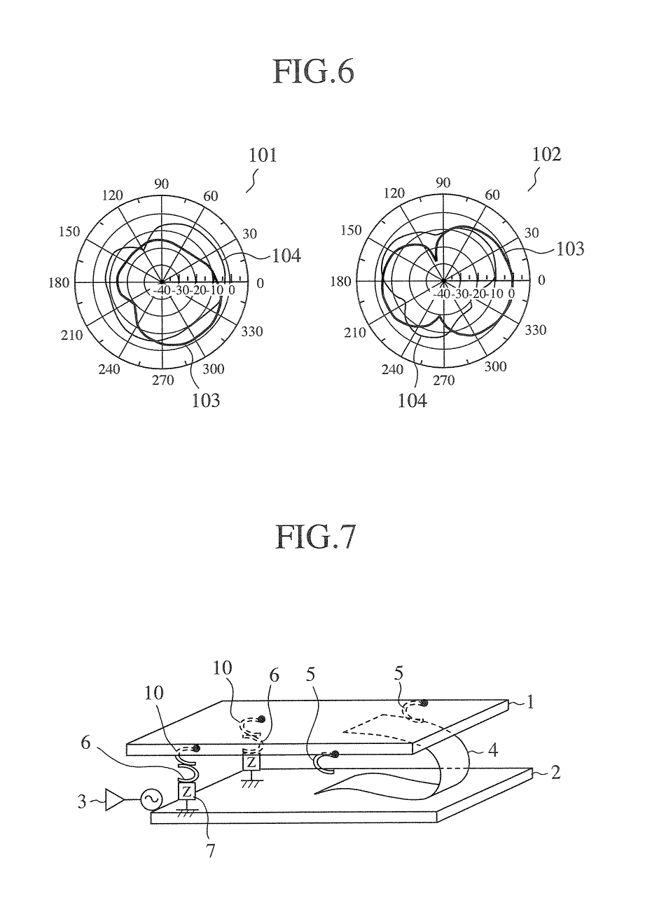

FIG. 6 is a chart explaining space radiation patterns, showing this state.

Referring to FIG. 6, a space pattern 101 is the case where one connecting terminal 5 and the other connecting terminal 6 are not in existence, and one ground conductor 1 and the other ground conductor 2 are connected only by the linear conductor 4. A space pattern 102 is the case where the directivity of the main polarization of the antenna is enhanced. Further, referring to FIG. 6, reference numeral 103 denotes the main polarization and reference numeral 104 denotes a vertical polarization. Here, observing a level of the main polarization 103 in the direction of 0°, it is turned out that the level thereof in pattern 102 has been become intense as compared with that in pattern 101. In other words, the directivity in the direction of 0° is proved to have been become intense.

It has a tendency to increase in the number of the states to be selected, with an increase in frequencies used and in the degree of complexity of the holding state of the portable wireless set. However, in the current portable wireless sets progressing day after day their miniaturization, an increase in the number of the radiating elements (antennas) depending on the frequencies used and the holding states of the portable wireless set invites aggrandizement of its outside dimension, and further installing two or more antennas presses one to consider coupling between the antennas. Hence, the arrangement of the first embodiment which optimizes the space radiation pattern, without increasing the number of antennas, is also valid from this viewpoint.

As mentioned above, according to the sliding-type portable wireless set of the first embodiment, since the sliding-type portable wireless set includes the radiating element, provided at least on any one ground conductor of a plurality of ground conductors; one and the other connecting terminals, respectively connected to one and the other ground conductors having the sliding structure among the plurality of ground conductors, and getting into an electrically connected state in drawing-out of these ground conductors; and a load, connected in series between one connecting terminal and one ground conductor, or between the other connecting terminal and the other ground conductor, it provides the sliding-type portable wireless set having the high-gain antenna best suited to a plurality of frequency bands and a variety of holding states of the portable wireless set.

Further, according to the sliding-type portable wireless set of the first embodiment, since the first embodiment is arranged such that an impedance of the load can be switched, it offers the sliding-type portable wireless set, having the high-gain antenna becoming optimum, even when adjustment to many frequency bands and the holding state of the portable wireless set are complicated.

### Second Embodiment

In the first embodiment, the sliding-type portable wireless set is arranged such that one connecting terminal 5 and the other connecting terminal 6 are electrically connected each other in drawing-out by sliding the casings, and these connecting terminals are disconnected each other in housing. Unlike the first embodiment, it is also possible to provide a housing-time connecting terminal for connecting it to the load in housing. And so, this arrangement will be now demonstrated hereat as the second embodiment.

FIG. 7 is a structural diagram showing the portable wireless set according to the second embodiment of the present invention, in the housed state of the casings.

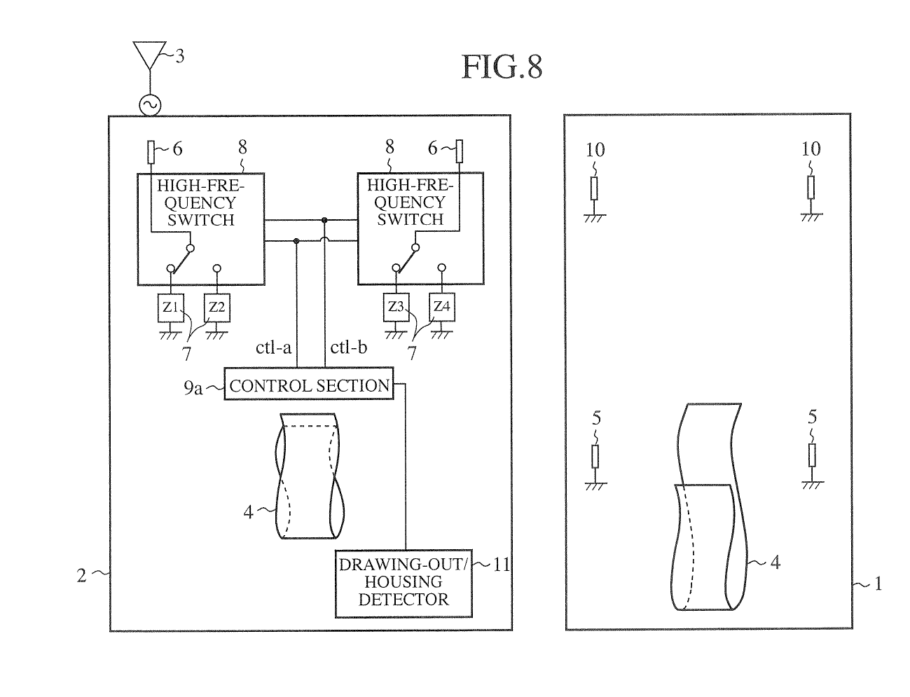

FIG. 8 is a structural diagram showing each of ground conductors of the portable wireless set according to the second embodiment of the present invention.

In the second embodiment, to one ground conductor is connected one connecting conductor 5, and is secured a housing-time connecting terminal 10. This housing-time connecting terminal 10 is a connector for connection in housing, provided at positions at which the converting terminal 10 is electrically connected to the other connecting terminal 6 provided on the other ground conductor 2 in housing, as shown in FIG. 7. Moreover, in the second embodiment, a drawing-out/housing detector 11 is a functional section detecting whether the casings are drawn out or housed, and delivering a detected signal to a control portion 9a. Moreover, the control section 9a is arranged to output control signals (ctl-a, ctl-b) for selecting the load, based on a drawing-out/housing detected signal from the drawing-out/housing detector 11 and information on the frequency bands used. Other configurations thereof are the same as those of the first embodiment. Therefore, the same sections are denoted by the same reference numerals, and explanations thereof are omitted for economy of space.

According to the second embodiment, in the drawn-out state, one connecting terminal 5 and the other connecting terminal 6 are connected to each other, and the drawing-out/housing detector 11 detects that the casings are in the drawn-out state. Thereby, the control section 9a controls the wireless set in the same manner as the first embodiment. For example, when selecting the load according to the frequencies f1, f2, the control section 9a sets the same value to the control signals (ctl-a, ctl-b) as those shown in FIG. 4 in the first embodiment.

Meanwhile, in the housed state of the casings, the other connecting terminal 6 is connected to the housing-time connecting terminal 10. At that time, the drawing-out/housing detector 11 detects that the casings are in the housed state, and outputs a detected signal showing that state to the control section 9a. This enables control of the high-frequency switch 8 even in the housed state, and therefore it is allowed to select the load 7, even in the housed state.

As described above, according to the sliding-type portable wireless set of the second embodiment, since the wireless set includes the housing-time connecting terminal connected to the ground conductor side to which the connecting terminal without the load is secured, and is arranged to get into an electrically connected state to the connecting terminal with the load, in housing of one and the other ground conductors, the connecting terminal allows a change in the space radiation patterns even when the casings are housed. Accordingly, the second embodiment produces space radiation patterns best suited to each of occasions in drawing-out and in housing, which provides the sliding-type portable wireless set, having the high-gain antenna becoming optimum no matter how bad conditions one is in.

Further, according to the sliding-type portable wireless set of the second embodiment, there is provided a drawing-out/housing detector detecting whether one and the other ground conductors are in the drawn-out state or in the housed state, and an impedance of the load can be switched depending on whether the casings are in the drawn-out state or in the housed state, detected by the drawing-out/housing detector. Hence, even when adjustment to many frequency bands and the holding state of the portable wireless set are complicated, switching to a space radiation pattern suitable for respective occasions in drawing-out and housing can be carried out. Therefore, the second embodiment provides the sliding-type portable wireless set having the high-gain antenna best suited under a variety of conditions.

### Third Embodiment

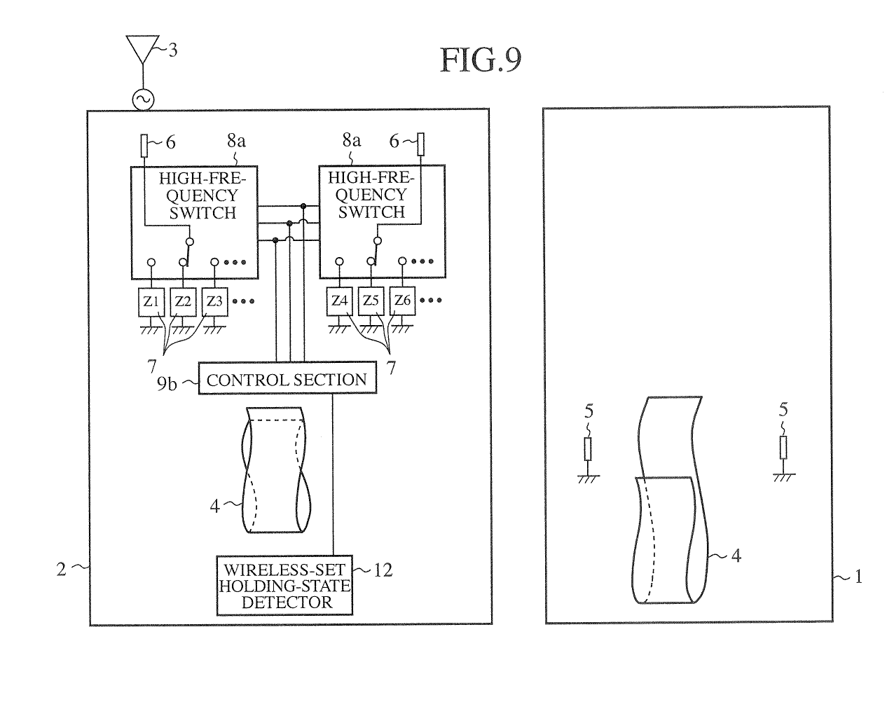

FIG. 9 is a structural diagram independently showing one ground conductor 1 and the other ground conductor 2 of the sliding-type portable wireless set of the third embodiment.

According to the third embodiment, it is arranged such that the load 7 has three or more different impedances (Z1, Z2, Z3, . . . ) and (Z4, Z5, Z6, . . . ), respectively, and the high-frequency switch 8a can select these load 7. In addition, a wireless-set holding-state detector 12 is provided.

The wireless-set holding-state detector 12 is implemented by using, e.g., an acceleration sensor or the like. The detector 12 is for detecting in what holding state the portable wireless set is maintained, such as whether the portable wireless set is held at a vertical position or at a horizontal position, and outputting a detected signal to the control section 9b. The control section 9b has a faculty of delivering a control signal to the high-frequency switch 8a based, e.g., on information on the frequency band used and the signal detected by the wireless-set holding-state detector 12.

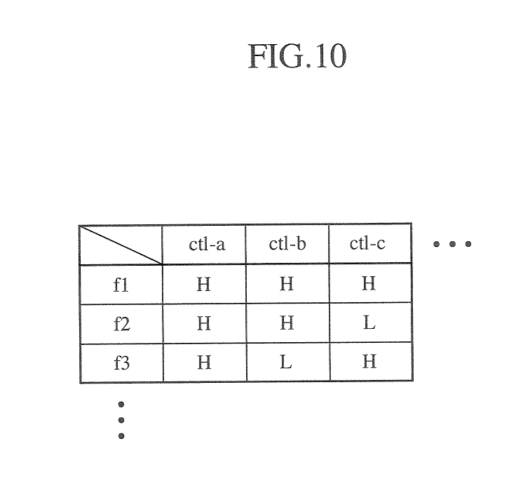

FIG. 10 is a table explaining a relationship between the control signals and the frequencies.

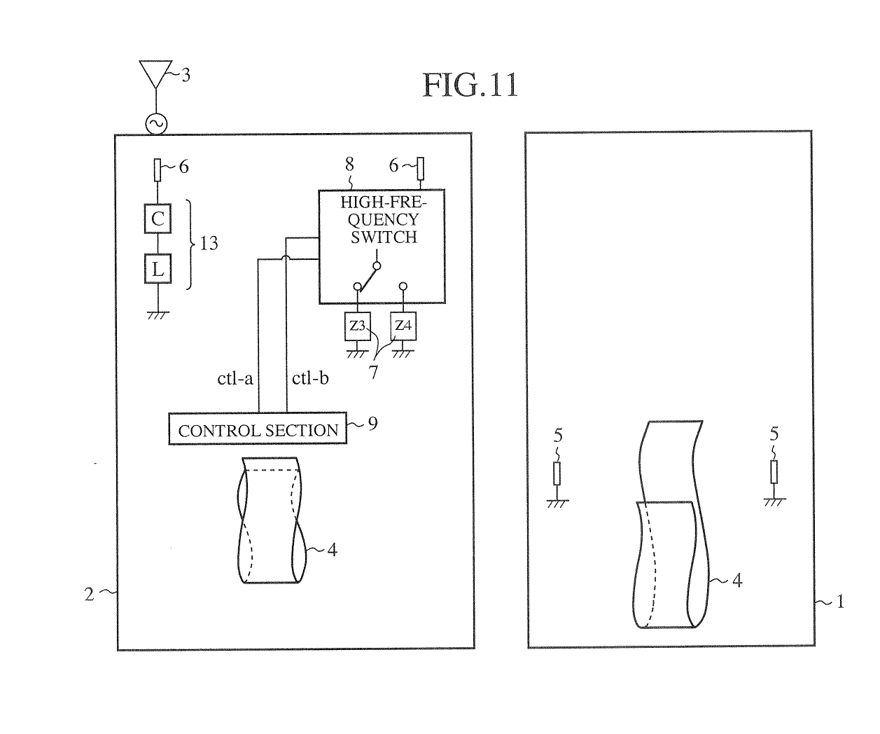

As shown in FIG. 11, a frequency used is selected by the control signals (ctl-a, ctl-b, ctl-c, . . . ).

In the sliding-type portable wireless thus arranged, when controlling radiation patterns corresponding to the frequency used, the control section 9b outputs a control signal corresponding to the frequency to the high-frequency switch 8a. For example, when the frequency is f1, the control signal ctl-a is “H”, the control signal ctl-b is “H”, and the control signal ctl-c is “H”.

Further, when controlling a radiation pattern based on the detected signal from the wireless-set holding-state detector 12, the control section 9b outputs the control signals ctl-a, ctl-b, ctl-c, . . . to the high-frequency switch 8a so as to select the load 7 corresponding to the holding state.

As described above, according to the sliding-type portable wireless set of the third embodiment, since it is arranged that three or more impedances of the load can be selected, it provides the sliding-type portable wireless set, having the high-gain antenna best suited to each of the holding states, even when adjustment to many more frequency bands and the holding state of the portable wireless set are complicated.

### Fourth Embodiment

FIG. 11 is a structural diagram showing each of ground conductors of the sliding-type portable wireless set according to the fourth embodiment of the present invention.

In the fourth embodiment, there is provided an LC series resonance circuit 13 as a circuit of which reactance changes depending on the frequency, in place of the load 7 and the high-frequency switch 8. That is, in the above-described first embodiment, it is arranged that radiation patterns can be changed in the frequency bands of f1 and f2, respectively, by changing the load 7 using the high-frequency switch 8. Unlike the first embodiment, in the fourth embodiment, it is arranged to exclude the high-frequency switch 8 of the above-mentioned first embodiment.

For example, assume that when f1 is set to 2.0 GHz and f2 is set to 800 MHz, a load of z1 is selected in case of f1, and a load z2 is selected in case of f2. If in the first embodiment, the loads selected at that time are Z1→short, and Z2→1.5 pF, an effect similar to that of the first embodiment can be exerted by using the LC series resonance circuit 13 of which reactance is short-circuited in the 2.0 GHz band and can attain approximately 1.5 pF in the 800 MHz band. Further, in the example shown in FIG. 11, the other load 7 (Z3, Z4) is arranged as with the first embodiment; however, in regard to this, too, it is possible to eliminate the need for the high-frequency switch 8 by replacing the switch with the LC series resonance circuit 13 in the same manner as the above. Furthermore, beyond the LC series resonance circuit 13, an effect equivalent to that of the fourth embodiment can be exerted, even by using capacitors in series, an inductor, 0 Ω (short circuitry), or an LC parallel resonance, in order to accomplish a desired reactance.

As described above, according to the sliding-type portable wireless set of the fourth embodiment, since a circuit of which reactance changes depending on the frequency is used as a load, it eliminates the need for the switch for switching the load and the control circuit around the switch. Therefore, it strives for cost down, which goes to miniaturization of the sliding-type portable wireless set, owing to elimination of part installation areas for a switch, and the like,

### Fifth Embodiment

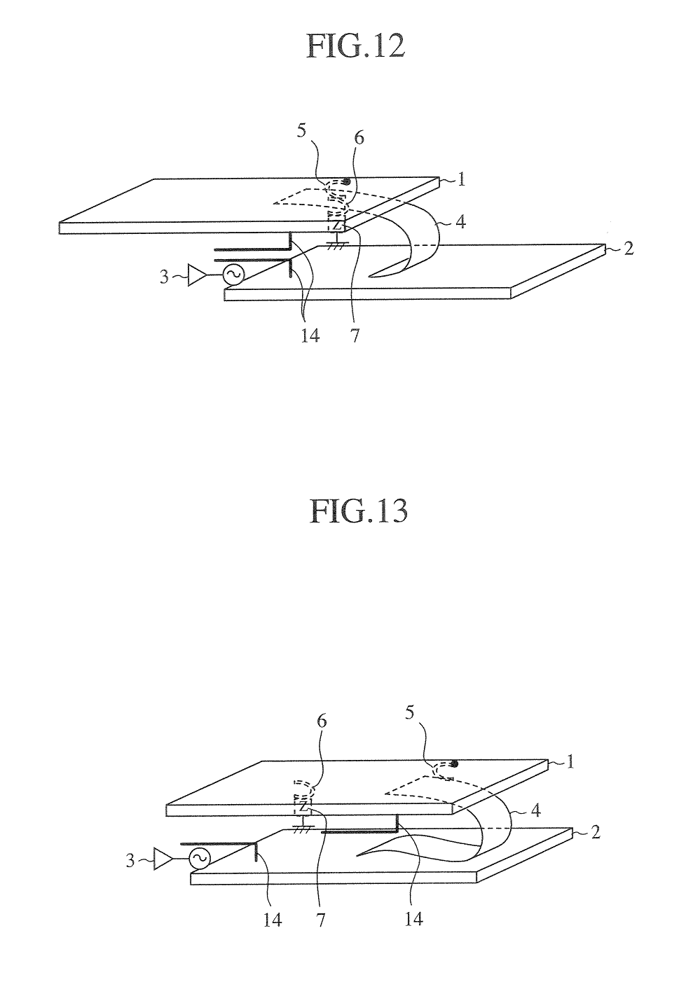

FIG. 12 and FIG. 13 are structural diagrams of a sliding-type portable wireless set according to the fifth embodiment. FIG. 12 shows the casings in drawing-out, and FIG. 13 shows the casings in housing.

According to the fifth embodiment, in lieu of one connecting terminal 5 to the high-frequency switch 8 of the first embodiment, a linear conductor 14 of which length is λ/4 of a specific frequency is provided on each of one ground conductor 1 and the other ground conductor 2. The linear conductors 14 are disposed at positions which close to each other in drawing-out of the casings and separate from each other in housing thereof.

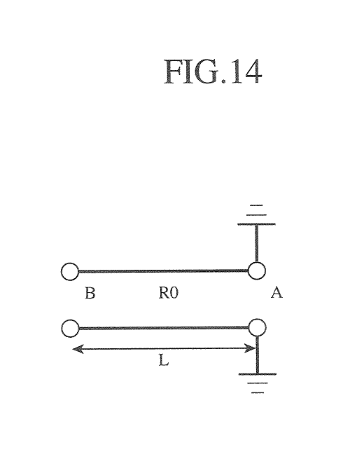

FIG. 14 is a diagram explaining the linear conductors 14.

An impedance Za viewed from A side to B side in FIG. 14 is an impedance of an open-ended transmission line. Namely, if a characteristic resistance of the transmission line is R0, the impedance Za is obtained by the following equation.
Za=I*R0*cot(KL),
where K is a wave number (=2π/λ), and L is the length of the line. If the length of the line L is λ/4, an impedance Za is 0 Ω (short). For example, the length of the line L is selected so as to become λ/4 in the 2.0 GHz band, thus achieving Za=0 Ω in the 2.0 GHz band. At that time, setting the R0, e.g., to a predetermined value in the 800 MHz band makes equal the impedance to a value equivalent to the load 7 (Z2, Z4) in the first embodiment.

with such an arrangement, the length of linear conductor 14 is arranged, e.g., to be λ/4 of a predetermined frequency in the 2.0 GHz band, which considers the impedance to be 0 Ω in the 2.0 GHz band in drawing-out of the casings, and actualizes an arrangement having a predetermined impedance in 800 MHz. Moreover, in housing of the casings, the linear conductors 14 disposed on the respective ground conductors are isolated from each other, as shown in FIG. 13, the space between one ground conductor 1 and the other ground conductor 2 gets into an open state.

Additionally, in the example shown in FIG.13, the linear conductors 14 are provided on one side in the sliding direction of each of one ground conductor 1 and the other ground conductor 2, and one connecting terminal 5 to the high-frequency switch 8 (illustration thereof is omitted) is provided on the other side. Alternatively, the linear conductors 14 may be provided on both sides thereof.

As described above, according to the sliding-type portable wireless set of the fifth embodiment, since there is provided the radiating element provided at least on any one ground conductor of a plurality of ground conductors; and linear conductors provided on one ground conductor and the other ground conductor, respectively, having the sliding structure, at positions which come close to each other in drawing-out of these ground conductors, and have the line length of a value corresponding to the wavelength of a predetermined frequency, it can do without expensive surface treatment and an effect equivalent to that of the above-described the first embodiment can be exerted, in disregards of a low piece.

That is, because one connecting terminal 5 and the other connecting terminal 6 are a movable contact, these connecting terminals are under an obligation to maintain a joint reliability thereof, even though they are subjected to frequent drawing-out and housing. As a result, one connecting terminal 5 and the other connecting terminal 6 necessitate plating expensive than that for usual connectors. However, the linear conductors 14 do not need to relay upon such surface treatment as they have no portion making contact with each other, even when the casings are drawn out and housed.

In each of the embodiments described hereinabove, since explanations have gone on citing the instance where the sliding-type portable wireless set has two ground conductors (one ground conductor 1 and the other ground conductor 2), these embodiments may be similarly applied, e.g., to a sliding-type portable wireless set having three or more ground conductors in which the sliding-type portable wireless set has a three-layer structure, and each of these ground conductors slides independently. Furthermore, in this case, the arrangement of each of the embodiments described above may be applied to all of the plurality of sliding portions, or to only one sliding portion thereof.

### INDUSTRIAL APPLICABILITY

As mentioned above, the sliding-type portable wireless set according to the present invention includes ground conductors having the sliding structure and improves space radiation patterns by adjusting itself to the service conditions and to the frequency bands used. Therefore, the portable wireless set is suitable for a portable telephone or its equivalent.

1. A sliding-type portable wireless set comprising:
a radiating element provided at least on any one ground conductor among a plurality of ground conductors;
one connecting terminal and the other connecting terminal connected to one ground conductor and the other ground conductor having a sliding structure, respectively among the plural ground conductors, and get into an electrically connected state each other in drawing-out of these ground conductors; and
a load connected in series between one connecting terminal and one ground conductor, or between the other connecting terminal and the other ground conductor.

2. The sliding-type portable wireless set according to claim 1, wherein an impedance of the load is switchable.

3. The sliding-type portable wireless set according to claim 1, comprising a housing-time connecting terminal connected to the ground conductor side, to which the connecting terminal without load is connected, is secured, and disposed so as to get into an electrically connected state to the connecting terminal with the load in housing of the one and the other ground conductors.

4. The sliding-type portable wireless set according to claim 3, wherein a drawing-out/housing detector is provided, which detects whether one and the other ground conductors are in the drawn-out state or the housed state, and an impedance of the load is switchable depending on the drawn-out state or the housed state detected by the drawing-out/housing detector.

5. The sliding-type portable wireless set according to claim 1, wherein a wireless-set holding-state detector is provided, which detects a holding state of one and the other ground conductors, and an impedance of the load is switchable depending on the holding state detected by the wireless-set holding-state detector.

6. The sliding-type portable wireless set according to claim 1, wherein a circuit of which reactance changes depending on a frequency is used as a load.

7. A sliding-type portable wireless set comprising:
a radiating element provided at least on any one ground conductor among a plurality of ground conductors; and
a linear conductor provided on one ground conductor and the other ground conductor, respectively, having a sliding structure among the plurality of ground conductors, at positions which come close to each other in drawing-out of these ground conductors, and each have a line length of a value corresponding to a wavelength of a predetermined frequency.
